(19) United States
(12) Patent Application Publication
(10) Pub. No.: US 2022/0415340 A1
(43) Pub. Date: Dec. 29, 2022

(54) SELECTIVE FINE-TUNING OF SPEECH

(71) Applicant: Avaya Management L.P., Durham, NC (US)

(72) Inventors: Kiran Barhate, Pune (IN); Harsimran Jeet Singh, Pune (IN); Jibin George, Pune (IN); Sandeep Goynar, Pune (IN)

(21) Appl. No.: 17/356,341

(22) Filed: Jun. 23, 2021

(51) Int. Cl. G10L 21/0364; G10L 15/02; G10L 21/034

(52) U.S. Cl. CPC G10L 21/0364; G10L 15/02; G10L 21/034; G10L 2015/025

(57) ABSTRACT

Speech conveyed over a network, such as during an electronic conference may be more difficult to understand if the recipient has difficulty understanding the speech of users having a particular speech attribute. However, other recipients may have no difficulty understanding the speech. As provided herein, speech provided by a user may have phonemes comprising accents or other speech pattern that, if removed, are more readily understood by a particular user. Such alterations are provided only to the users that require it, such as by a server or a specific user's communication device, without affecting the speech concurrently presented to other users.

### COPYRIGHT NOTICE

A portion of the disclosure of this patent document contains material that is subject to copyright protection. The copyright owner has not objected to the facsimile reproduction by anyone of the patent document or the patent disclosure as it appears in the Patent and Trademark Office patent files or records, but otherwise reserves all copyright rights whatsoever.

### FIELD OF THE DISCLOSURE

The invention relates generally to systems and methods for altering waveform properties and particularly to speech modification to aid a recipient in understanding the speech of a speaker.

### BACKGROUND

In electronic conferences, participants may communicate by providing their voice and their manner of speaking as an audio portion of the conference, with the objective of concluding the conference successfully. Conferences with a number of participants have various personas involved and their voices may be their only way of expressing themselves. Accordingly, each participant's voice plays a vital role in electronic conferences.

Different individuals may have different patterns of speech. These differences may be an obstacle to effective communication during a conference. Some of these differences may be cultural or regional patterns of speech that are not understood or are misunderstood by other participants from different regions or have different cultural backgrounds. For example, one participant's normal vocalized expression may be perceived as shouting by other participants. Similarly, speaking at a very fast pace may not be difficult to understand by those who routinely interact with the speaker or have a similar background, but may be difficult to understand or convey an unintended meaning to others not familiar with the speaker or of a different background.

Many current conferencing solutions utilize noise reduction or other filtering to help reduce the effect of background or line noise, such solutions are limited to waveform modifications (e.g., tone-shifting, band filtering, etc.). However, despite the improvements such processes provide, problems remain. For example, participants currently need to manage their own vocal identity and also accommodate the vocal identities of other speakers, including those that may have vocal identities that they are less accustomed to and have more difficulty in understanding. As a consequence, participants may have to ask the speaker to repeat misunderstood content, ask the speaker to alter their normal pattern of speech away from their natural way of speaking, or disregard certain misunderstood content and hope that such missed content can be obtained elsewhere.

### SUMMARY

In order to provide efficient and effective electronic conferences, individuals cannot be distracted by tasks unrelated to obtaining the content of speech provided by others, such as when a recipient of another's speech is focusing on trying to understand what words are spoken by another. There is a need to alter certain vocal aspects of the speaker in an electronic conference while maintaining other aspects, such as to allow a speaker's voice to be presented by a system to other participants in a way that is more understandable by the recipient, such as to make the speaker's voice crisper or clearer.

These and other needs are addressed by the various embodiments and configurations of the present invention(s). The present invention(s) can provide a number of advantages depending on the particular configuration. These and other advantages will be apparent from the disclosure of the invention(s) contained herein.

In one embodiment, a model is built on an individual's voice aspects, which may be based, in whole or in part on historic records of past speech. From the model, a conference grammar may be built. The speech, as modified, is then presented to improve effective communication in a conference. As a benefit, participants may focus on the agenda or other purpose of the conference and less on trying to understand particular words or “joining the dots” when only pieces of a presenter's speech are understood in order to form an assumed conclusion of what the speaker is talking about.

In one embodiment, the content of a communication is altered so as to present the content of what is said by a speaker, in a voice call or an audio portion of an audio-video conference call, to a recipient of the speech. This speaker-recipient misalignment may be due to individual speaking patterns and/or speaking pattern characteristics of a particular region. For example, recipient A may be known to have difficulty in understanding speaker A and/or an attribute of recipient A, such as a current or historical region of residence, may be known to be problematic in understanding speaker B, or those from the same current or historic region of residence as speaker B. Accordingly, personal or regional patterns of speech may be neutralized, such as to be more standard, and/or replaced with personal or regional patterns of speech readily understood by the recipient. For example, speakers having a pattern of speech common to certain East Coast states may say “water” as “wooder” or “wooter.” As provided by the systems and methods herein, such speech may be altered to be presented to a recipient as “water” and thereby remove the accent. Additionally or alternatively, an alternative accent, such as one associated with the recipient may be utilized to cause an alternative insertion, such as “wooter,” if such an accent is better understood by the recipient. Similarly, a speaker's tone may be altered, up or down, and their speech buffered and presented to a recipient at a slower pace. Such alterations may be performed for all speech or just a portion, words, phonemes, utterances, etc. For example, a speaker may loudly blurt out “thatgivesmeanidea . . . ” (“that gives me an idea . . . ” ran together). A phoneme being perceptually distinct units of sound spoken. Accordingly, the volume may be lowered, and the speech buffered and presented with gaps between the words. Optionally, the buffering may compress the individual words in order to create the gap between words, if such a methodology is more readily understood by the recipient.

The degree to which speech is altered may be characterized as one of a number of levels. The initiation or escalation from one level to another level of speech modification may be determined by a manual input, such as by the recipient or by an automated system, such as an artificial intelligence (AI), such as a neural network, to automatically detect the presence of actionable speech pattern, and/or the level of the modification.

The systems and methods herein may tonally modify the speech, such as to volume-balance the speech so the volume is not too above a high threshold or below a low threshold; pitch, pace, or inflection of the speech may be modified to remove the regional attributes of the speaker and/or insert regional attributes of the recipient.

In another embodiment, speech may be converted to text and then presented to the recipient and/or utilized to generate speech to comprise the content spoken but with speech attributes that are more aligned with those of the recipient.

An AI system may be seeded with default values for what is previously determined to be a regional speech attribute. This may be further limited to a recipient's demographic, such as country or region of origin, age, hearing impairment, etc. to account for the different perceptions of speech. The AI may receive inputs from the recipient, or others having a similar demographic attributes related to speech and comprehension of speech that indicate their perception of a particular portion of spoken content provided by a speaker. The input may be manual, such as by turning a dial, whether physical or embodied as a graphical element on a display device, or otherwise providing a direct indication of the recipient's perception of the communication or a portion of a communication.

Additionally or alternatively, a particular agent's interests, likes, dislikes, and express or implicit tolerance for certain behavior of others may be derived from social media posts, likes, dislikes, etc. An agent's past history with the same person, or similar personality may also be utilized, such as to determine past communication content that was, or was not, indicated as acceptable or tolerable.

While no agent may enjoy certain negative expressions directed toward them in a communication, in another embodiment, a threshold level or type of negative expression is determined that is likely to impact the agent's performance in the current call, subsequent call, or over a period of subsequent calls.

In another embodiment, the communication is text base. Accordingly, systems and methods are provided to replace emotionally-charged words or other expressions with words of similar meaning having less emotion (e.g., “I am upset”), substitute characters (e.g., a string of asterisks or other characters), whitespace, etc.

In another embodiment, the AI system would also mask/blur the customer's face, body, or body portion to mask their physical appearance while speaking offensive speech that is audibly blocked or masked and/or obscure or block the customer's body such as to conceal obscene gestures, offensive messages on apparel or otherwise within view of the customer's camera, etc. In some embodiments, mere blocking (e.g., blur, white box/black box, etc.) may be provided. In other embodiments, a “deep fake” masking of the image may be provided to overlay the offensive image with a neutral, or at least less emotionally charged, image.

While the content to be attenuated or redacted may be negatively emotionally-charged content, it another embodiment, the content may be attenuated or redacted if determined to violate a company's standards or rules of ethical behavior. For example, in a conference call, an “off color” joke may be determined to be offensive or otherwise against company policy, even though the speaker may believe they are promoting humor, enjoyment, or other positive emotion. Similarly, a passing comment about a negatively-charged event, such as a natural disaster, may be considered to be normal ‘small talk,’ or even friendly, but if the agent or agent's family was impacted by the natural disaster, the performance of the agent may be impacted by such an emotionally charged comment that may have no particular effect on another agent.

The embodiments herein may be directed to other two-party communications beyond those of a customer and agent, as well as to incorporate three or more people. Each person may have their own standard for what is negatively emotionally charged, such as offensive or considered as a personal attack, etc. Accordingly, the background, ethnicity, origin, etc., of each participant may be determined and content presented or attenuated/blocked varied on an individual basis. For example, two companies may be conducting a mediation or arbitration to resolve a dispute outside of the court system. The reason for the dispute may be emotionally-charged with various participants “venting” and verbally attacking the individuals on the other side. By attenuating or redacting the attacks, the need for the party being attacked to retaliate and further exacerbate the attacks is diminished, thereby promoting a more factual conversation to resolve the issue. However, it may be required that a mediator or arbitrator hear exactly what is being said and be presented with the raw communication.

As a benefit of the embodiments described herein, a conversation may be maintained with more focus on the content related to the purpose of the conversation, and not on the emotional or distracting content that may be provided with the content.

In one embodiment, a communications system, comprising: a network interface to a network; and a processor comprising machine-readable instructions that when read by the processor cause the processor to perform: receive speech from a first user device, utilized by a first user, and designated for delivery via the network to a number of recipient user devices comprising a second user device, utilized by a second user; upon determining the speech comprises spoken content comprising a first speech attribute of the first user, collecting a first recipient attribute of the second user; comparing the first recipient attribute to the first speech attribute; collecting a first modification to apply to the speech when the first recipient attribute differs from the first speech attribute by more than a previously defined threshold; automatically applying the first modification to the speech to create a first modified speech; and providing the first modified speech to the second user device.

In another embodiment, a method is disclosed, comprising: receiving by a processor speech from a first user device, utilized by a first user, and designated for delivery via a network to a number of recipient user devices comprising a second user device, utilized by a second user; upon determining the speech comprises spoken content comprising a first speech attribute of the first user, collecting a first recipient attribute of the second user; comparing the first recipient attribute to the first speech attribute; collecting a first modification to apply to the speech when the first recipient attribute differs from the first speech attribute by more than a previously defined threshold; automatically applying the first modification to the speech to create a first modified speech; and providing the first modified speech to the second user device.

In another embodiment, a system is disclosed, comprising: means to receive speech from a first user device, utilized by a first user, and designated for delivery via a network to a number of recipient user devices comprising a second user device, utilized by a second user; means to, upon determining the speech comprises spoken content comprising a first speech attribute of the first user, collecting a first recipient attribute of the second user; means to compare the first recipient attribute to the first speech attribute; means to collect a first modification to apply to the speech when the first recipient attribute differs from the first speech attribute by more than a previously defined threshold; means to automatically apply the first modification to the speech to create a first modified speech; and means to provide the first modified speech to the second user device.

A system on a chip (SoC) including any one or more of the above embodiments or aspects of the embodiments described herein.

One or more means for performing any one or more of the above embodiments or aspects of the embodiments described herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above embodiments or aspects, wherein the data storage comprises a non-transitory storage device comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a first system in accordance with embodiments of the present disclosure;

FIG. 2 depicts a data structure in accordance with embodiments of the present disclosure;

FIG. 3 depicts a modification of a waveform in accordance with embodiments of the present disclosure;

FIG. 4 depicts a process in accordance with embodiments of the present disclosure; and

FIG. 5 depicts a second system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with a like reference number. When such a reference is made in the singular form, but without identification of the sub-reference identifier, is a reference one of the like numbered elements, but without limitation as to the particular one of the elements. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

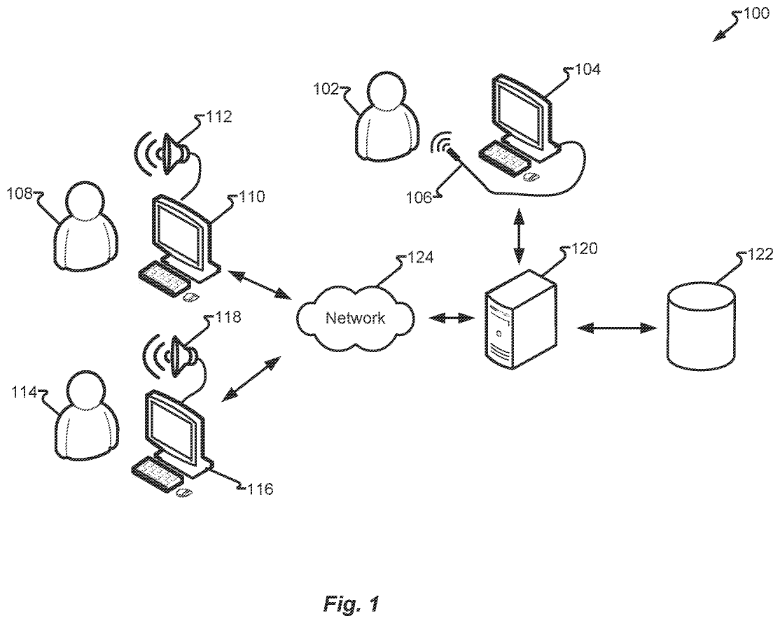

FIG. 1 depicts system 100 in accordance with embodiments of the present disclosure. In one embodiment, speaking user 102 is speaking and providing speech captured by microphone 106 and encoded (e.g., digitized, compressed, etc.) such as by one or more processors of user device 104 and/or server 120 to enable transmission via a network, such as network 124 and/or other network configured to convey waveform (analog) speech and/or digital (packetized) speech. First user device 110 then presents speech, which may be altered speech (described below), for decoding and outputting via speaker 112 for first receiving user 108. Optionally, additional receivers, such as second receiving device 116 may receive the speech from speaking user 102, via network 124, which may be unaltered speech for presentation by speaker 118 for second receiving user 114 or, alternatively, differently altered speech that has been altered from the speech provided by speaking user 102 but altered dissimilarly from the altered speech presented to first receiving user 108.

It should be appreciated that the topology and components illustrated in system 100 are one embodiment and that other embodiments may utilize other configurations without departing from the scope of the disclosure. For example, while each user device (e.g., user device 104, first user device 110, second receiving device 116) is illustrated as a personal computer, other form factors may be utilized in addition or replacement thereof, such as a tablet computer, laptop computer, smart phone, and/or other device operable to send and/or receive, at least, audio data encoded for transmission via network 124, decoded and/or encode the audio data for receiving and/or transmitting speech to and/or by a user.

Server 120 comprises at least one processor with a network interface to network 124. Server 120 may be a conferencing server, such as to receive speech from participants (e.g., speaking user 102, first receiving user 108, second receiving user 114, etc.) and broadcast the receive speech back to the participants. Server 120 may further include conference management features, such as floor control, connection management, bandwidth management (e.g., selection and utilization of a particular audio codec), etc. With the embodiments herein are directed to audio and, more specifically, speech which may be encoded as an audio channel of an electronic conference. Server 120 may incorporate other encoded content, such as a video/data channel comprising images of one or more participants, other images, documents, text chat messages, etc. Server 120 may utilize data storage 122 to store data records (e.g., attendees of an electronic conference, documents shared, recordings of audio and/or video/data channels, etc.).

In yet another embodiment, the functionality of server 120 may be incorporated into a user device, such as one of user device 104, first user device 110, second receiving device 116, etc. While only one speaking user is illustrated (i.e., speaking user 102) and two receiving users (i.e., first receiving user 108 and second receiving user 114), it should be appreciated that more speaking and/or receiving users, each with their respective user device interconnected via network 124 may be utilized. Additionally or alternatively, the roles of speakers and listeners may be dynamic, wherein a user that is speaking user 102 may transition (intermittently, permanently, or concurrently) to be a receiving user (e.g., first user device 110) and vice versa. For example, two or more users may engage in a back-and-forth conversation, altering between the roles of speaking user 102 and first receiving user 108 or second receiving user 114 and/or a number of users may simultaneously be speaking user(s) 102, which occurs if users are “talking over” each other. Accordingly, first user device 110 and/or second receiving device 116 may comprise microphones and user device 104 may comprise a speaker and/or other input-output components. In one embodiment, the roles of the users remains static such that speaking user 102 is the sole speaking user providing speech (which may be altered) to recipients first receiving user 108 and optionally second receiving user 114.

Human speech and comprehension of speech is a complex and nuanced form of communication. Often individuals have difficulty understanding each other, even when speaking the same language. This can be due to a hearing attribute of the receiver of the speech, such as a band of frequencies to which the recipient is partially or totally deaf. However, devices are often able to amply all or certain frequencies or frequency-shift tones to provide more of the speech within the bands the recipient is able to hear. In other instances, understanding may be due to a speech attribute of the speaking user. For example, a speaking user may have a particular pattern of speech, such as an accent that results from living in a particular region during the speaking user's formative years. As a result, the speaking user may have a pattern of speech common to the majority of speakers of the region. The region may be a part of the same country or characteristic of a different country. As a result, a speaker may emphasize, deemphasize, speed-up, slow-down, omit, insert, or replace phonemes. For replacement, the replacement may be a single phoneme for two or more phonemes or two or more phonemes replacing a single phoneme. Other speech attributes may be due to an individual's pattern of speech (e.g., tone of voice) which may include speech impediments (e.g., slurs, lisps, etc.).

In another embodiment, speech from speaking user 102 may be determined to have a particular attribute known or determined to impede understanding of the spoken content by first receiving user 108. For example, speaking user 102 may be from, or grew-up, in a region that is difficult for first receiving user 108 to understand. Accordingly, server 120 and/or a client device, such as first user device 110 may alter the speech so as to remove the attribute from the speech but without changing the meaning of the spoken content. The removal of the attribute may comprising adding, removing, or substituting one or more phonemes to be more neutral. For example, in the United States television, movies, and radio programs made for national audiences will utilize speakers having a neutral or “midland” accent (a category of “accents” noted for being substantially devoid of accented speech). Additionally or alternatively, altering the speech may insert phonemes as accents so as to allow first receiving user 108 to receive the speech as if speaking user 102 had a particular speech attribute readily understood by first receiving user 108.

Embodiments herein may be applied to an entire communication, wherein each recipient (e.g., first receiving user 108 and second receiving user 114) receives the speech of speaking user 102 as altered to remove a particular pattern of speech. In another embodiment, a subset of recipients may receive altered speech concurrently with unaltered speech being received by other recipients. For example, speaking user 102 may speak with a cockney English accent that is difficult to understand by first receiving user 108 and, therefore, the speech is altered to, in whole or in part, remove the attributes that comprise the accent without modifying the content of the speech. However, second receiving user 114 may have no difficulty understanding a cockney accent and, concurrently with first receiving user 108 receiving modified speech altered to remove the cockney accent, second receiving user 114 receives the content without the modification. Additionally or alternatively, first receiving user 108 and second receiving user 114 may receive, via first user device 110 and second receiving device 116, respectively, the speech from speaking user 102 as modified dissimilarly. For example, first receiving user 108 and second receiving user 114 may require a different degree of attenuation of the speech attribute of speaking user 102. In another example, a pattern of speech may be added to the raw or modified speech, differently between first receiving user 108 and second receiving user 114, such as when first receiving user 108 prefers or requires a Scottish accent and second receiving user 114 requires a Northern Irish accent, whereas speaking user 102 has an attribute of their speech such as an American deep-southern drawl. Whatever the specific alteration applied, in no case is any alteration utilized that would change the meaning of the speech.

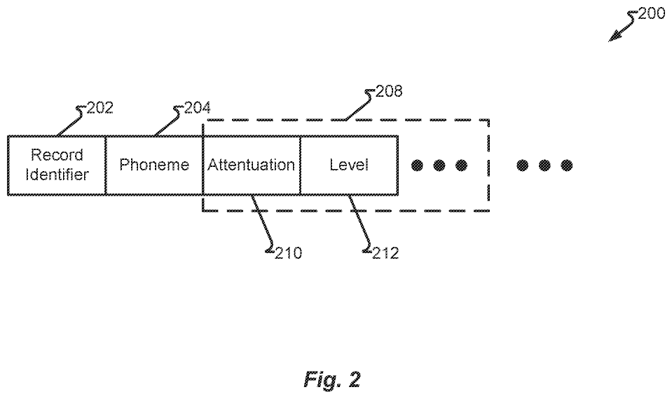

FIG. 2 depicts data structure 200 in accordance with embodiments of the present disclosure. Data structure 200 may be embodied as a record of a database maintained in data storage 122 and/or other data storage. In one embodiment, data structure 200 comprises record identifier 202 and an associated phoneme 204. Additionally or alternatively, phonemes 204 may identify combinations of phonemes. Data block 208 comprises one or more fields for attenuating the phoneme. For example attenuation may comprise a specific phoneme, wither digitized or analog waveform, and various degrees or levels, as indicated in field 212. For example, speaking user 102 may say “wooder,” matching the contents of phoneme field 204. Attenuation field 210 and associated level 212, alone or with additional attenuation fields 210 and associated levels 212 of data block 208, may then provide one or more attenuations. For example, replacing the “d” phoneme with a “t” phoneme, replacing the “oo” phoneme with a “ah” phoneme, etc. As a result, the speech is altered and presented to sound more like “water.” Optionally, the alteration may be to a particular degree necessary to promote understanding by first receiving user 108 and/or second receiving user 114. For example, second receiving user 114 may readily understand “wah-tah”, a first and lower level of alteration, and first receiving user 108 may require more alteration and understand “wah-tor.”

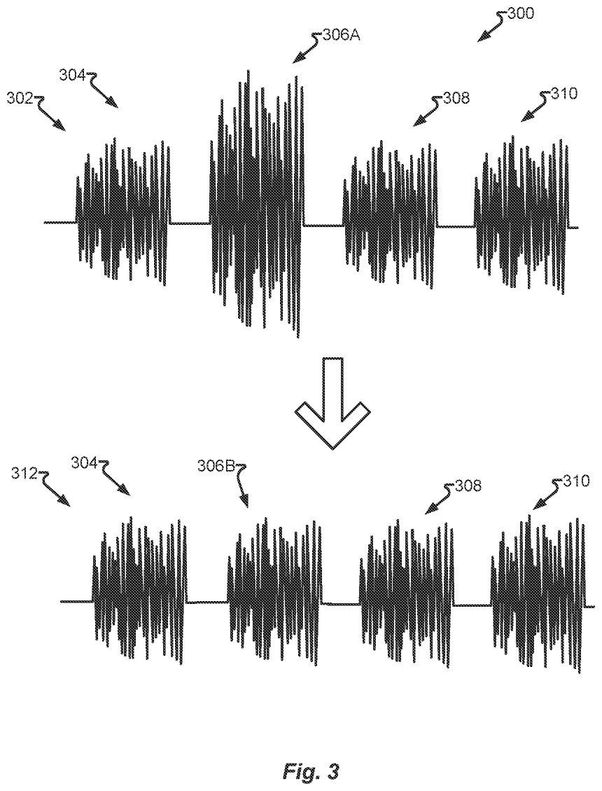

FIG. 3 depicts modification 300 of waveform 302 in accordance with embodiments of the present disclosure. Waveform 302 may be an unprocessed wave form having the speech attribute. It should be appreciated, that a waveform or digital equivalent is not considered “processed” when the processing is limited to encoding, decoding data compression, data decompression, or other processing that would still be provided to speech even if the speaking user (e.g., speaking user 102) did not have the speech attribute. For example, waveform 302 may have four phonemes, phonemes 304, 306A, 308, and 310. Phoneme 306A is louder, which may cause comprehension issues for first receiving user 108.

Waveform 312 is processed, such as by one or more processors of user device 104, server 120, first user device 110, and second receiving device 116. In altering waveform 302, phoneme 306A is altered to be waveform 306B. Additionally or alternatively, waveform 306B may be a substitute that replaces waveform 306A. While analog waveforms are illustrated by modification 300, it should be appreciated that digital equivalents describing individual sound attributes are also contemplated.

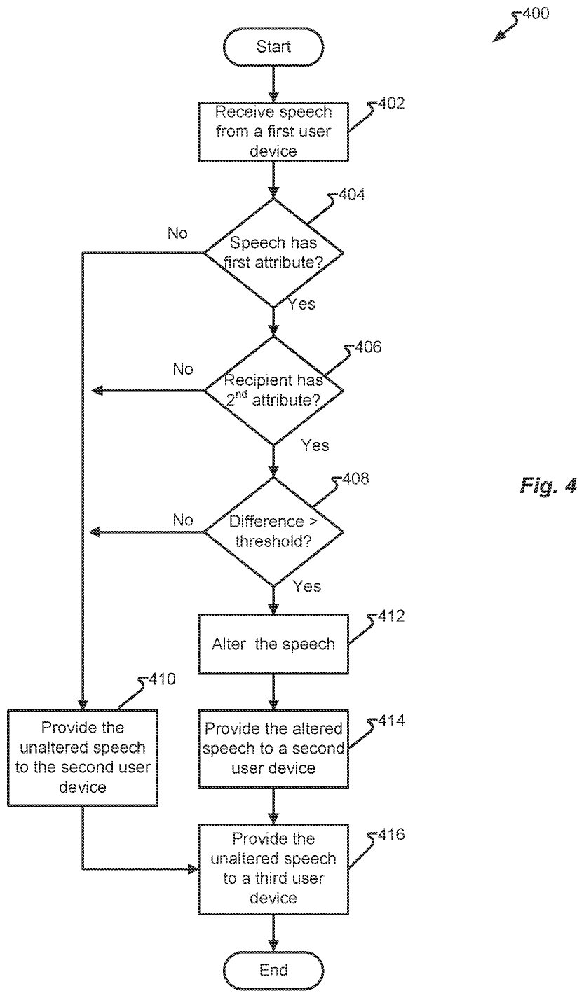

FIG. 4 depicts process 400 in accordance with embodiments of the present disclosure. In one embodiment, process 400 may be embodied as machine-readable instructions maintained in a non-transitory data storage and, when read by a machine, such as a processor of user device 104, server 120, first user device 110, or second receiving device 116, cause the processor to perform the steps of process 400.

Process 400 beings and step 402 receives speech from a first user, such as speaking user 102. Test 404 determines if the speech has a speech attribute known to be a hinderance to understanding to a particular recipient, such as first receiving user 108. If test 404 is determined in the negative, processing continues to step 410 wherein unaltered speech is provided to the recipient. If test 404 is determined in the affirmative, processing continues to test 406 to determine whether the recipient has a second recipient attribute. The second attribute may comprise one of a previously indicated difficulty with a particular accent or other speech, a demographic region of origin, etc. If test 406 is determined in the negative, processing continues to step 410. If test 406 is determined in the affirmative, processing continues to step 408 wherein a difference is determined. For example, a recipient may have no difficulty understanding the first attribute of the speaker, such as when it is a slight southern drawl, but great difficulty if it is a strong southern drawl. Similarly, some recipients will understand a particular speaker having a particular first attribute, whereas other recipients will have greater difficulty in understanding such a speaker. If the difference is below the threshold, test 408 is determined in the negative and processing continues to step 410. If the difference is at or above the threshold, processing continues to step 412.

Step 412 collects a modification, such as a filtering, tonal application, tonal shifting, etc., necessary to effectively remove the attribute and/or replace the attribute with a different attribute known to be readily understood by the recipient, such as to cause the speech to more closely resemble the second attribute. The modification may be maintained as a record defined by data structure 200 in data storage 122 and/or other data repository. The processor may collect a first set of information, such as the phoneme spoken and received in step 402 and, based on the specific phoneme or context (a series of phonemes comprising the specific phoneme), the processor may gather additional information, such as the attenuation to apply and/or the degree of attenuation (see data structure 200). The processor may monitor the communication, such as to determine if the recipient indicated understanding (e.g., responded in manner that addressed the speech comprising the specific phoneme) or a lack of understanding (e.g., “say that again” or a specific input associated with an absence of understanding) and alter the attenuation, or level of attenuation. As result, the speech provided to the recipients that can understand is unaltered and speech that requires alteration is altered as little as necessary and for as few participants as necessary, so as to not waste processing and other computing resources altering the speech unnecessarily. Without benefit of the embodiments described herein, computing and networking components maybe over utilized as communications may become protracted as recipients require the repeating of speech provided by a user with a particular speech attribute not conducive to their own understanding.

Step 414 then provides the altered speech to the recipient user, such as to first receiving user 108 via first user device 110. Step 416 provides the unaltered speech concurrently to a third device, such as to second receiving device 116.

Process 400 may loop or operate continually while a communication over a network is underway. As a benefit, speech that is difficult for one user to understand, but not difficult for other users to understand, may be provided concurrently to each of the user. Synchronization of the speech between altered and non-altered speech may be provided so that each recipient receives the content, altered and unaltered, at the same time. Additionally, the processing required to alter the data may be performed on a local client (e.g., first user device 110), providing device (e.g., user device 104), or a server (e.g., server 120) and delivered to only those users (e.g., first receiving user 108) that require altered speech who may not otherwise be able to understand the speech provided by speaking user 102 due to regional or other speech attributes.

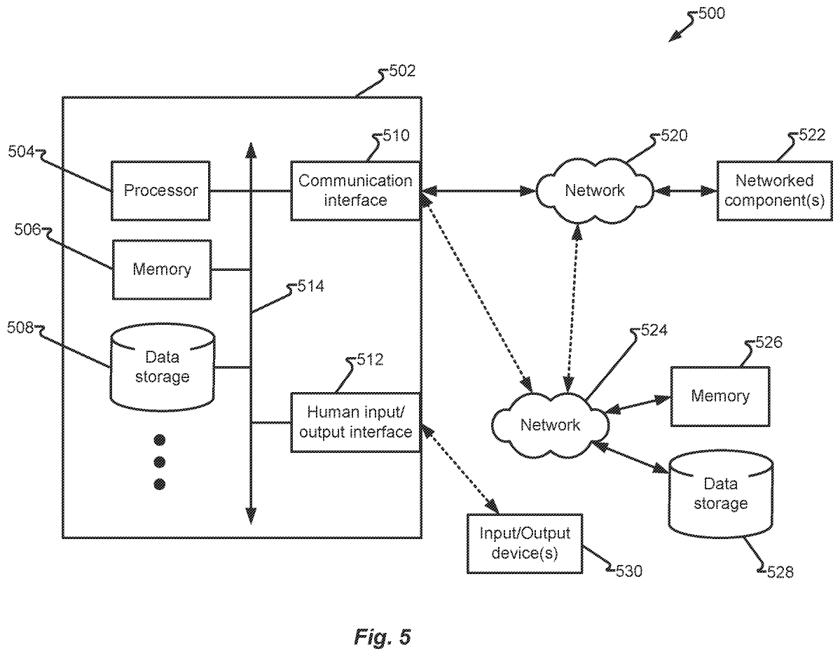

FIG. 5 depicts device 502 in system 500 in accordance with embodiments of the present disclosure. In one embodiment, user device 104, server 120, and/or first user device 110 may be embodied, in whole or in part, as device 502 comprising various components and connections to other components and/or systems. The components are variously embodied and may comprise processor 504. The term “processor,” as used herein, refers exclusively to electronic hardware components comprising electrical circuitry with connections (e.g., pin-outs) to convey encoded electrical signals to and from the electrical circuitry. Processor 504 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 514, executes instructions, and outputs data, again such as via bus 514. In other embodiments, processor 504 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 504 is a non-transitory computing device (e.g., electronic machine comprising circuitry and connections to communicate with other components and devices). Processor 504 may operate a virtual processor, such as to process machine instructions not native to the processor (e.g., translate the VAX operating system and VAX machine instruction code set into Intel® 9xx chipset code to allow VAX-specific applications to execute on a virtual VAX processor), however, as those of ordinary skill understand, such virtual processors are applications executed by hardware, more specifically, the underlying electrical circuitry and other hardware of the processor (e.g., processor 504). Processor 504 may be executed by virtual processors, such as when applications (i.e., Pod) are orchestrated by Kubernetes. Virtual processors allow an application to be presented with what appears to be a static and/or dedicated processor executing the instructions of the application, while underlying non-virtual processor(s) are executing the instructions and may be dynamic and/or split among a number of processors.

In addition to the components of processor 504, device 502 may utilize memory 506 and/or data storage 508 for the storage of accessible data, such as instructions, values, etc. Communication interface 510 facilitates communication with components, such as processor 504 via bus 514 with components not accessible via bus 514. Communication interface 510 may be embodied as a network port, card, cable, or other configured hardware device. Additionally or alternatively, human input/output interface 512 connects to one or more interface components to receive and/or present information (e.g., instructions, data, values, etc.) to and/or from a human and/or electronic device. Examples of input/output devices 530 that may be connected to input/output interface include, but are not limited to, keyboard, mouse, trackball, printers, displays, sensor, switch, relay, speaker, microphone, still and/or video camera, etc. In another embodiment, communication interface 510 may comprise, or be comprised by, human input/output interface 512. Communication interface 510 may be configured to communicate directly with a networked component or utilize one or more networks, such as network 520 and/or network 524.

Network 124 may be embodied, in whole or in part, as network 520. Network 520 may be a wired network (e.g., Ethernet), wireless (e.g., WiFi, Bluetooth, cellular, etc.) network, or combination thereof and enable device 502 to communicate with networked component(s) 522. In other embodiments, network 520 may be embodied, in whole or in part, as a telephony network (e.g., public switched telephone network (PSTN), private branch exchange (PBX), cellular telephony network, etc.)

Additionally or alternatively, one or more other networks may be utilized. For example, network 524 may represent a second network, which may facilitate communication with components utilized by device 502. For example, network 524 may be an internal network to a business entity or other organization, whereby components are trusted (or at least more so) that networked components 522, which may be connected to network 520 comprising a public network (e.g., Internet) that may not be as trusted.

Components attached to network 524 may include memory 526, data storage 528, input/output device(s) 530, and/or other components that may be accessible to processor 504. For example, memory 526 and/or data storage 528 may supplement or supplant memory 506 and/or data storage 508 entirely or for a particular task or purpose. For example, memory 526 and/or data storage 528 may be an external data repository (e.g., server farm, array, “cloud,” etc.) and allow device 502, and/or other devices, to access data thereon. Similarly, input/output device(s) 530 may be accessed by processor 504 via human input/output interface 512 and/or via communication interface 510 either directly, via network 524, via network 520 alone (not shown), or via networks 524 and 520. Each of memory 506, data storage 508, memory 526, data storage 528 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 530 may be a router, switch, port, or other communication component such that a particular output of processor 504 enables (or disables) input/output device 530, which may be associated with network 520 and/or network 524, to allow (or disallow) communications between two or more nodes on network 520 and/or network 524. One of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components and included, in one or more embodiments, voltages in memory circuits, configuration of switching circuits, and/or by selective use of particular logic gate circuits. Additionally or alternative, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessor may be integrated into a single processing appliance (e.g., computer, server, blade, etc.) or located entirely or in part in a discrete component connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A communications system, comprising:
a network interface to a network; and
a processor comprising machine-readable instructions that when read by the processor cause the processor to perform:
receive speech from a first user device, utilized by a first user, and designated for delivery via the network to a number of recipient user devices comprising a second user device, utilized by a second user;
upon determining the speech comprises spoken content comprising a first speech attribute of the first user, collecting a first recipient attribute of the second user;
comparing the first recipient attribute to the first speech attribute;
collecting a first modification to apply to the speech when the first recipient attribute differs from the first speech attribute by more than a previously defined threshold;
automatically applying the first modification to the speech to create a first modified speech; and
providing the first modified speech to the second user device.

2. The communication system of claim 1, wherein the number of recipient user devices further comprise a third user device, utilized by a third user, and the modified speech from the first user device is provided to the second user device concurrently with the conference content provided to a third user device utilized by a third user.

3. The communication system of claim 2, wherein conference content provided to the third user device comprises unmodified speech from the first user.

4. The communication system of claim 2, wherein the processor further performs:
upon determining the speech comprises spoken content comprising the first speech attribute of the first user, collecting a second recipient attribute of the third user;
comparing the second recipient attribute to the first speech attribute;
collecting a second modification to apply to the speech when the second recipient attribute differs from the first speech attribute by more than a previously defined threshold;
automatically applying the second modification to the speech to create a second modified speech; and
providing the second modified speech to the third user device.

5. The communication system of claim 1, wherein the processor comprises at least one processor of the second user device.

6. The communication system of claim 1, wherein:
the processor comprises at least one processor of a conferencing server receiving the spoken content and integrating the spoken content into an electronic conference comprising at la first and second encoded audio streams, wherein the first audio stream comprises the first modified speech provided to the second user device and the second encoded audio stream comprises the spoken content comprising the first speech attribute provided to at least one other user device different from the first user device.

7. The communication system of claim 1, wherein the first speech attribute comprises at least one of an accent.

8. The communication system of claim 1, wherein the processor creates the first modified speech to comprise the spoken content without the first speech attribute, further comprising altering the spoken content comprising one or more of redacting, filtering, tonal filtering, amplifying, tonal amplifying, buffering with slowed playback, or buffering with accelerated playback and wherein the performing the alteration further comprises performing the alteration on at least one of the entirety of the spoken content, select words of the words spoken, or select phonemes of the phonemes uttered and wherein the meaning of the spoken content is unaltered.

9. The communication system of claim 1, wherein the processor creates the first modified speech to comprise the spoken content without the first speech attribute, further comprising altering the spoken content comprising one or more of substituting a phoneme for a phoneme uttered, substituting two or more phonemes for one phoneme, or substituting one phoneme for two or more phonemes and wherein the meaning of the spoken content is unaltered.

10. The communication system of claim 1, wherein the processor determines the speech comprises spoken content, comprising a first speech attribute of the first user, from a historic record of prior speech of the first user.

11. The communication system of claim 1, wherein the processor determines the speech comprises spoken content, comprising a first speech attribute of the first user, from a demographic attribute of the first user.

12. A method, comprising:
receiving by a processor speech from a first user device, utilized by a first user, and designated for delivery via a network to a number of recipient user devices comprising a second user device, utilized by a second user;
upon determining the speech comprises spoken content comprising a first speech attribute of the first user, collecting a first recipient attribute of the second user;
comparing the first recipient attribute to the first speech attribute;
collecting a first modification to apply to the speech when the first recipient attribute differs from the first speech attribute by more than a previously defined threshold;
automatically applying the first modification to the speech to create a first modified speech; and
providing the first modified speech to the second user device.

13. The method of claim 12, wherein the number of recipient user devices further comprise a third user device, utilized by a third user, and the modified speech from the first user device is provided to the second user device concurrently with the conference content provided to a third user device utilized by a third user.

14. The method of claim 13, wherein conference content provided to the third user device comprises unmodified speech from the first user.

15. The method of claim 13, further comprising:
upon determining the speech comprises spoken content comprising the first speech attribute of the first user, collecting a second recipient attribute of the third user;
comparing the second recipient attribute to the first speech attribute;
collecting a second modification to apply to the speech when the second recipient attribute differs from the first speech attribute by more than a previously defined threshold;
automatically applying the second modification to the speech to create a second modified speech; and
providing the second modified speech to the third user device.

16. The method of claim 12, wherein the processor comprises at least one processor of the second user device.

17. The method of claim 12, wherein:
the processor comprises at least one processor of a conferencing server receiving the spoken content and integrating the spoken content into an electronic conference comprising at la first and second encoded audio streams, wherein the first audio stream comprises the first modified speech provided to the second user device and the second encoded audio stream comprises the spoken content comprising the first speech attribute provided to at least one other user device different from the first user device.

18. The method of claim 12, wherein the first speech attribute comprises at least one of an accent or speech impediment.

19. The method of claim 13, wherein creating the first modified speech to comprise the spoken content without the first speech attribute, further comprising altering the spoken content comprising one or more of redacting, filtering, tonal filtering, amplifying, tonal amplifying, buffering with slowed playback, or buffering with accelerated playback and wherein the performing the alteration further comprises performing the alteration on at least one of the entirety of the spoken content, select words of the words spoken, or select phonemes of the phonemes uttered and wherein altering the spoken content further comprising one or more of substituting a phoneme for a phoneme uttered, substituting two or more phonemes for one phoneme, or substituting one phoneme for two or more phonemes and wherein the meaning of the spoken content is unaltered.

20. A system, comprising:
means to receive speech from a first user device, utilized by a first user, and designated for delivery via a network to a number of recipient user devices comprising a second user device, utilized by a second user;
means to, upon determining the speech comprises spoken content comprising a first speech attribute of the first user, collecting a first recipient attribute of the second user;
means to compare the first recipient attribute to the first speech attribute;
means to collect a first modification to apply to the speech when the first recipient attribute differs from the first speech attribute by more than a previously defined threshold;
means to automatically apply the first modification to the speech to create a first modified speech; and
means to provide the first modified speech to the second user device.
